(19) United States
(12) Patent Application Publication
(10) Pub. No.: US 2005/0147943 A1
(43) Pub. Date: Jul. 7, 2005

(54) Dental implant fixture

(76) Inventor: Sang-Kohn Chang, Daegu-si (KR)

Correspondence Address: R. Neil Sudol, 714 Colorado Avenue, Bridgeport, CT, 06605-1601, US

(21) Appl. No.: 10/918,986

(22) Filed: Aug. 16, 2004

(30) Foreign Application Priority Data
Jan. 6, 2004 (KR) 2004-0000468

(51) Int. Cl. A61C 8/00

(52) U.S. Cl. 433/174; 433/173

(57) ABSTRACT

The present invention relates to dental implant fixture capable of achieving an easier engagement and disengagement operations using a screw by forming a threaded portion and a circular plate pin portion in an external cylindrical surface of an fixture and preventing a screw from being loosened by using a circular plate pin, thereby achieving a stable placement and easier implant surgical operation. The improved dental implant fixture comprises a threaded portion formed in an upper external cylindrical surface of the fixture for achieving an easier and convenient engagement and disengagement; and a plurality of circular plate pins provided in a lower external cylindrical surface for enhancing a stability when an alveolar bone is grown, wherein the hole has a deeper space at a bottom end for preventing an air compression problem when the post portion of the abutment is assembled.

### BACKGROUND OF THE INVENTION

1. Field of the Invention

The present invention relates to a dental implant fixture. More particularly, the present invention relates to an improved fixture of a tapered locking type having a threaded portion and a circular plate pin portion in an external cylindrical surface. And a deeper space is additionally formed in an inner bottom of a hole into which a post portion of an abutment is inserted, thereby preventing a loosening due to compressed air. In addition the deeper space is formed in a wrench groove, thereby achieving an easier implant surgical operation.

2. Description of the Background Art

Dental implant system is that an abutment is attached to a fixture inserted into an alveolar bone and a crown covers the abutment. Each implant is independently anchored, and the anchored implant does not rely on neighboring teeth for support. Therefore, it is not needed to damage natural teeth for supporting the damaged tooth. According to a situation, it is possible to stably fix an artificial tooth. The life span of the implant is long, and an outer look is very good.

In the screw-type dental implant systems known so far, there are an external connection method and an internal connection method. In the locking taper methods of the non-screw type dental implant systems, there is an internal connection method that does not need a screw.

The screw-type dental implant system needs a lot of parts, so that a fabrication and maintenance cost are high. In addition, since implant surgical operation is complicated, complication arises and the patients may pay a lot of costs.

Accordingly, an internal connection method has been developed and has been generally used in order to prevent the screw from being loosened. More preferred method is the non-screw type that does not need screws.

In particular, since the parts are engaged by screws in the above dental implant system, the maximum external force including an interlocking force, etc. is determined based on an outer diameter (width) of a thread, and a width and length of an fixture. So if the support force disappears, a screw would be loosened.

In the screw-type dental implant system, when an interlocking function is performed in a oral cavity, a compression force is relatively high. But when a tensional force is getting higher, the screw could be easily loosened.

An attachment features between the fixture and the abutment may have a problem, so that a certain gap is formed therein. Since bacteria may be infected through the gap, a hygiene problem may occur. In addition, inflammation may occur in the infected portions, so that alveolar bone may be damaged.

As shown in FIG. 1, the non-screw type dental implant has been developed in order to overcome the above problems of the screw-type. The non-screw type dental implant is basically directed to a tapered locking method achieved in such a manner that the engagement between parts is achieved based on a surface friction force.

Namely, when a hole of the fixture is assembled with a post portion of the abutment, a taper shaft and a taper hole prevent the screw from being loosened.

However, a conventional tapered locking type has the following disadvantages.

First, in a conventional art, a circular plate pin 12 only is formed on an external cylindrical surface of the fixture 10, and the circular plate pin 12 is anchored in an alveolar bone. But since the type is not-screw type, it is difficult to insert and disengage the fixture at implant surgical operation.

Second, the post portion 21 of the abutment 20 may be lifted up from the hole 13 of the fixture 10 due to the compressed air, so that the assembled state may be getting worse.

Namely, as shown in FIG. 1, both the hole 13 of the fixture and the post portion 21 of the abutment 20 are tapered in shape. When the post portion 21 is inserted into the hole 13, a very small distance is formed between the end surface 22 of the post portion 21 and the bottom surface 14 of the hole 13.

In the above state, since the assembling operation is performed in such a manner that the post portion 21 of the abutment 20 compresses the air in the interior of the hole 13, so that the air makes the post portion 21 lift up continuously.

Therefore, as the time is passed, the post portion 21 of the abutment 20 may be escaped, so that the artificial tooth could not be stably supported.

Third, during implanting the operation that the implant is engaged to the alveolar bone and is disengaged from the same may be repeatedly performed. Therefore, the engagement and disengagement works are complicated.

Namely, the threaded portion is formed in an external cylindrical surface of the fixture 10. As shown in FIG. 1, since the conventional fixture does not have wrench groove, an operation work of the fixture is not easy.

### SUMMARY OF THE INVENTION

Accordingly, it is a general object of the present invention to provide an improved fixture such that many of the problems related to implant placement are eliminated.

It is more specific object of the present invention to provide an dental implant fixture capable of achieving an easier engagement and disengagement operation using a screw by forming a threaded portion and a circular plate pin portion in a external cylindrical surface of a fixture and preventing a screw from being loosened by using a circular plate pin, thereby achieving a stable placement and easier surgical operations.

It is another object of the present invention to prevent a loosening due to a compressed air in such a manner that a deeper space is formed in an inner bottom of a hole into which a post portion of an abutment is inserted.

Still another object of the present invention is to achieve an easier surgical operation in such a manner that the deeper space is formed in a shape of a wrench groove, and a screw portion is formed.

To achieve the above objects, in a dental implant that includes a fixture having a tapered hole on a cylindrical upper surface, an abutment that has a taper post portion inserted into the hole of the fixture, and a crown that is assembled to an upper side of the abutment, there is provided an improved fixture, comprising a threaded portion formed in an upper external cylindrical surface of the fixture for achieving an easier and convenient engagement and disengagement; and a plurality of circular plate pins provided in a lower external cylindrical surface of the fixture for enhancing a stability when an alveolar bone is grown, wherein the hole has a deeper space at a bottom end for preventing an air compression problem when the post portion of the abutment is assembled.

A diameter of the circular plate pin is smaller than a diameter of the thread of the threaded portion, and the deeper space has a hexagonal hole in its inner portion wherein the hexagonal hole operates as a wrench groove.

### BRIEF DESCRIPTION OF THE DRAWINGS

The present invention will become better understood with reference to the accompanying drawings which are given only by way of illustration and thus are not limitative of the present invention, wherein;

FIG. 1 is a view illustrating a conventional fixture;

FIG. 2 is a front view illustrating a fixture according to the present invention;

FIG. 3 is a cross sectional view illustrating a fixture according to the present invention;

FIG. 4 is a plant view of the preferred embodiment of a fixture of the present invention; and

FIG. 5 is a cross sectional view of the preferred embodiment of a fixture of the present invention.

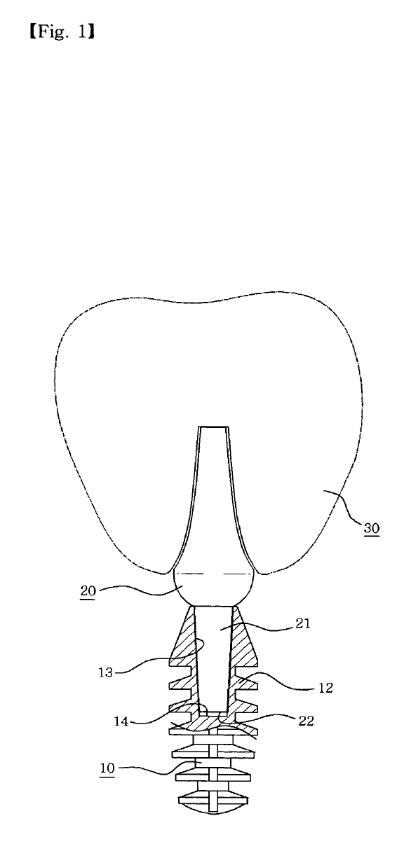

### DETAILED DESCRIPTION OF THE PREFERRED EMBODIMENTS

The present invention will now be described more fully hereinafter with reference to the accompanying drawings, in which preferred embodiments of the invention are shown.

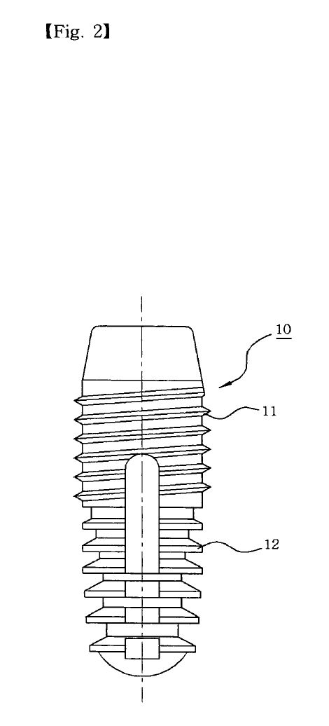

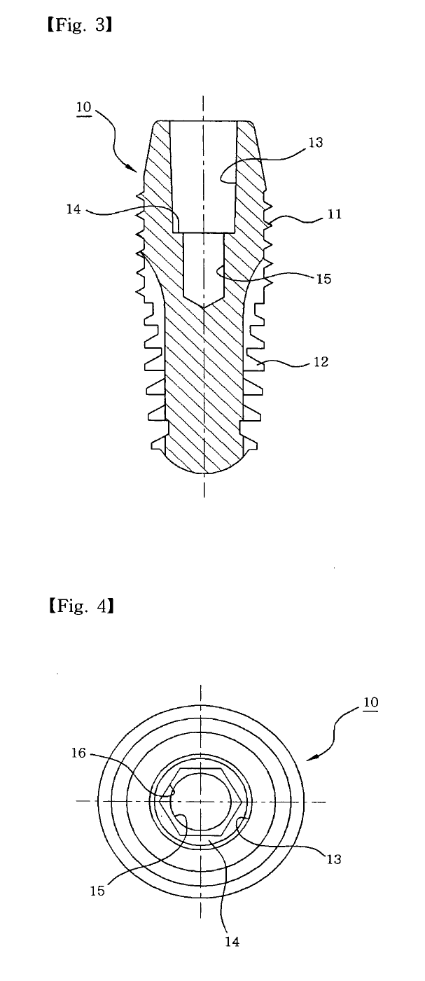

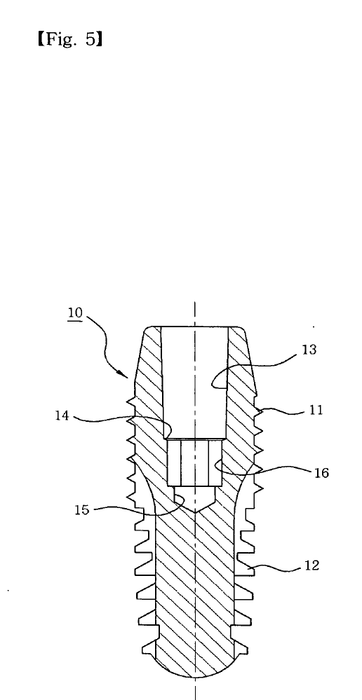

FIG. 2 is a front view of a fixture, FIG. 3 is a cross sectional view of the fixture, FIG. 4 and FIG. 5 respectively are a plant view and a cross sectional view of the preferred embodiment of a fixture of the present invention.

The dental implant system includes a fixture 10 having a tapered hole 13 on a cylindrical upper surface, an abutment 20 that has a taper post portion 21 inserted into the hole 13 of the fixture, and a crown 30 that is assembled to an upper side of the abutment.

With reference now to FIG. 2, the fixture 10 has a threaded portion 11 formed in an upper external cylindrical surface and a plurality of circular plate pins 12 formed in a lower external cylindrical surface.

In addition, the threaded portion 11 is provided for achieving an easier engagement and disengagement operation of the fixture when the fixture 10 is anchored in place of missing and/or extracted tooth. In addition, the circular plate pins 12 are provided for enhancing a stable support when an alveolar bone is grown.

FIG. 3 depicts a deeper space 15 forming at a bottom end of the hole 13 of the fixture 10.

The deeper space 15 makes the inner space of the hole 13 enlarge, so that an air compression problem is overcame when the post portion 21 of the abutment 20 is inserted and assembled in the hole 13.

As shown in FIG. 5, the deeper space 15 may be formed with a hexagonal shape or a rectangular shape in its inner portion, thereby using a wrench groove 16.

When the fixture 10 is anchored in the alveolar bone, the engagement and disengagement operations are repeatedly performed. At this time, since the wrench groove 16 is formed in the above manner, it is easy to anchor or disengage the fixture by inserting a wrench (not shown) in the wrench groove 16 and rotating the same because the threaded portion 11 is formed in the external cylindrical surface.

As described above, in the present invention, the upper and lower portions of the external cylindrical surface of the fixture are formed the threaded portion and the circular plate pins respectively, so that an engagement and disengagement operation are easily performed by the threads, and the loosening is prevented by the circular plate pins. Therefore the present invention achieves an easier and convenient operation in combination with the above two functions.

In addition, since the deeper space is formed in the inner bottom of the hole into which the post portion of the abutment is inserted, the air compression due to the insertion of the post portion is minimized. Therefore, it is possible to prevent a loosening problem due to the air compression like in the conventional art.

Since the inner portion of the deeper space is formed with a rectangular or hexagonal wrench groove, it is possible to implement an easier operation in which the fixture is inserted into the alveolar bone using a wrench.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In an dental implant system that includes a fixture 10 having a tapered hole 13 on a cylindrical upper surface, an abutment 20 that has a taper post portion 21 inserted into the hole 13 of the fixture, and a crown 30 that is assembled to an upper side of the abutment, an improved dental implant fixture, comprising:
a threaded portion 11 formed in an upper external cylindrical surface of the fixture 10 for achieving an easier and convenient engagement and disengagement; and
a plurality of circular plate pins 12 provided in a lower external cylindrical surface of the fixture for enhancing a stability when an alveolar bone is grown,
wherein said hole 13 has a deeper space 15 at a bottom end 14 for preventing an air compression problem when the post portion 21 of the abutment 20 is assembled.

2. The fixture of claim 1, wherein a diameter of the circular plate pin 12 is smaller than a diameter of the thread of the threaded portion 11.

3. The fixture of claim 1, wherein said deeper space 15 of the fixture 10 has a hexagonal hole in its inner portion wherein said hexagonal hole operates as a wrench groove 16.
